(19) United States
(12) Patent Application Publication
(10) Pub. No.: US 2026/0148695 A1
(43) Pub. Date: May 28, 2026

(54) DUAL VIEW DISPLAY DEVICE

(71) Applicant: LG Display Co., Ltd., Seoul (KR)

(72) Inventor: Young-Kyu SHIN, Paju-si (KR)

(73) Assignee: LG Display Co., Ltd., Seoul (KR)

(21) Appl. No.: 19/346,110

(22) Filed: Sep. 30, 2025

(30) Foreign Application Priority Data
Nov. 26, 2024 (KR) 10-2024-0170825

(51) Int. Cl. G09G 3/3233; G09G 3/32

(52) U.S. Cl. CPC G09G 3/3233; G09G 3/32; G09G 2330/021

(57) ABSTRACT

A dual view display device can include a display panel having a display area and a non-display area, a first transistor connected to a high level signal and a second node, a second transistor connected to the second node and a fourth node, a third transistor connected to the first node and the second node, a fourth transistor connected to the fourth node, a fifth transistor connected to a third node and a reference signal, a sixth transistor connected to the third node, and a seventh transistor connected to the fourth node. The seventh transistor of the left subpixel and the seventh transistor of the right subpixel are switched according to a left emission control signal and a right emission control signal, respectively.

### CROSS-REFERENCE TO RELATED APPLICATION

The present application claims priority to Korean Patent Application No. 10-2024-0170825, filed in the Republic of Korea on Nov. 26, 2024, which is hereby incorporated by reference in its entirety.

### BACKGROUND

### Field of the Disclosure

The present disclosure relates to a display device, and more particularly, to a dual view display device where luminance's of left and right images displayed at left and right viewing zones, respectively, are independently adjusted.

### Description of the Related Art

Recently, with the advent of an information-oriented society, the interest in information displays for processing and displaying a massive amount of information and the demand for portable information media have increased. Further, as a request for using a portable information media increases, various light and thin flat panel display devices have been developed and highlighted.

Among the various flat panel display devices, an organic light emitting diode (OLED) display device is an emissive type device that does not include a backlight unit used in a non-emissive type device such as a liquid crystal display (LCD) device. As a result, the OLED display device has advantages in a viewing angle, a contrast ratio and a power consumption to be applied to various fields.

Specifically, the OLED display device has been used for a dashboard of a vehicle. In a field of a vehicle, a dual view OLED display device where a driver and a passenger can watch different images has been researched and developed.

In a dual view OLED display device, left and right images are displayed at left and right viewing zones, respectively, using a film or a lens. However, since the left and right images are displayed using a single emission signal, luminances of the left and right images are not independently adjusted.

### SUMMARY OF THE DISCLOSURE

Accordingly, the present disclosure is directed to a display device that substantially obviates one or more of the problems due to limitations and disadvantages of the related art.

More specifically, the present disclosure is to provide a dual view display device where luminances of left and right images are independently adjusted and a low power consumption is obtained by disposing emission control transistors switched according to left and right emission control signals in left and right subpixels, respectively, displaying left and right images.

Further, the present disclosure is to provide a dual view display device where luminances of left and right images are independently adjusted and a low power consumption is obtained by switching emission transistors of left and right subpixels displaying left and right images according to left and right emission signals, respectively.

Additional features and advantages of the disclosure will be set forth in the description which follows, and in part will be apparent from the description, or can be learned by practice of the disclosure. These and other advantages of the disclosure will be realized and attained by the structure particularly pointed out in the written description and claims hereof as well as the appended drawings.

To achieve these and other advantages and in accordance with the purpose of the present disclosure, as embodied and broadly described herein, a dual view display device includes a display panel including a display area having a left subpixel and a right subpixel and a non-display area at a periphery of the display area; a first transistor in each of the left subpixel and the right subpixel, the first transistor switched according to a voltage of a first node and connected to a high level signal and a second node; a second transistor in each of the left subpixel and the right subpixel, the second transistor switched according to an emission signal and connected to the second node and a fourth node; a third transistor in each of the left subpixel and the right subpixel, the third transistor switched according to a second scan signal and connected to the first node and the second node; a fourth transistor in each of the left subpixel and the right subpixel, the fourth transistor switched according to the second scan signal and connected to the fourth node; a fifth transistor in each of the left subpixel and the right subpixel, the fifth transistor switched according to the emission signal and connected to a third node and a reference signal; a sixth transistor in each of the left subpixel and the right subpixel, the sixth transistor switched according to a first scan signal and connected to the third node; and a seventh transistor in each of the left subpixel and the right subpixel, the seventh transistor connected to the fourth node, wherein the seventh transistor of the left subpixel and the seventh transistor of the right subpixel are switched according to a left emission control signal and a right emission control signal, respectively.

In another aspect of the present disclosure, a dual view display device includes a display panel including a display area having a left subpixel and a right subpixel and a non-display area at a periphery of the display area; a first transistor in each of the left subpixel and the right subpixel, the first transistor switched according to a voltage of a first node and connected to a high level signal and a second node; a second transistor in each of the left subpixel and the right subpixel, the second transistor connected to the second node and a fourth node; a third transistor in each of the left subpixel and the right subpixel, the third transistor switched according to a second scan signal and connected to the first node and the second node; a fourth transistor in each of the left subpixel and the right subpixel, the fourth transistor switched according to the second scan signal and connected to the fourth node; a fifth transistor in each of the left subpixel and the right subpixel, the fifth transistor connected to a third node and a reference signal; and a sixth transistor in each of the left subpixel and the right subpixel, the sixth transistor switched according to a first scan signal and connected to the third node, wherein the second transistor of the left subpixel and the second transistor of the right subpixel are switched according to a left emission signal and a right emission signal, respectively.

It is to be understood that both the foregoing general description and the following detailed description are explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this disclosure, illustrate embodiments of the disclosure and together with the description serve to explain the principles of the disclosure.

In the drawings:

FIG. 1 is a view showing a dual view display device according to a first embodiment of the present disclosure;

FIG. 2 is a circuit diagram showing a left subpixel and a right subpixel of a dual view display device according to the first embodiment of the present disclosure;

FIG. 3 is a view showing a plurality of signals of a left subpixel and a right subpixel of a dual view display device according to the first embodiment of the present disclosure;

FIG. 4 is a plan view showing a left subpixel and a right subpixel of a dual view display device according to the first embodiment of the present disclosure;

FIG. 5 is a cross-sectional view showing a left subpixel and a right subpixel of a dual view display device according to the first embodiment of the present disclosure;

FIG. 6 is a circuit diagram showing a left subpixel and a right subpixel of a dual view display device according to a second embodiment of the present disclosure; and

FIG. 7 is a view showing a plurality of signals of a left subpixel and a right subpixel of a dual view display device according to the second embodiment of the present disclosure.

### DETAILED DESCRIPTION OF THE EMBODIMENTS

Advantages and features of the present disclosure, and implementation methods thereof will be clarified through following example aspects described with reference to the accompanying drawings. The present disclosure may, however, be embodied in different forms and should not be construed as limited to the example aspects set forth herein. Rather, these example aspects are provided so that this disclosure can be sufficiently thorough and complete to assist those skilled in the art to fully understand the scope of the present disclosure.

The shapes, sizes, ratios, angles, numbers, and the like, which are illustrated in the drawings to describe various example aspects of the present disclosure, are merely given by way of example. Therefore, the present disclosure is not limited to the illustrations in the drawings. Like reference numerals refer to like elements throughout the disclosure, unless otherwise specified.

In the following description, where the detailed description of the relevant known function or configuration can unnecessarily obscure a feature or aspect of the present disclosure, a detailed description of such known function or configuration can be omitted or a brief description can be provided.

Where the terms such as “comprise,” “have,” “include,” and the like are used, one or more other elements can be added unless the term, such as “only,” is used. An element described in the singular form is intended to include a plurality of elements, and vice versa, unless the context clearly indicates otherwise.

In construing an element, the element is to be construed as including an error or a tolerance range even where no explicit description of such an error or tolerance range is provided.

Where positional relationships are described, for example, where the positional relationship between two parts is described using terms such as “on,” “over,” “under,” “above,” “below,” “beside,” “next,” or the like, one or more other parts can be located between the two parts unless a more limiting term, such as “immediate(ly),” “direct(ly),” or “close(ly)” is used. For example, where an element or layer is disposed “on” another element or layer, a third layer or element can be interposed therebetween.

Although the terms such as “first,” “second,” A, B, (a), (b), and the like can be used herein to refer to various elements, these elements should not be interpreted to be limited by these terms as they are not used to define a particular order or precedence. These terms are only used to distinguish one element from another. For example, a first element could be termed a second element, and, similarly, a second element could be termed a first element, without departing from the scope of the present disclosure.

The term “at least one” should be understood to include all combinations of one or more of related elements. For example, the term of “at least one of first, second and third elements” can include all combinations of two or more of the first, second and third elements as well as the first, second or third element. Further, the term “can” fully encompasses all the meanings and coverages of the term “may” and vice versa.

The term “display device” can include a display device in a narrow sense such as liquid crystal module (LCM), an organic light emitting diode (OLED) module and a quantum dot (QD) module including a display panel and a driving unit for driving the display panel. In addition, the term “display device” can include a complete product (or a final product) including the LCM, the OLED module and the QD module such as a notebook computer, a television, a computer monitor, an equipment display device including an automotive display apparatus or a shape other than a vehicle, and a set electronic apparatus or a set device (or a set apparatus) such as a mobile electronic apparatus of a smart phone or an electronic pad.

Accordingly, a display device of the present disclosure can include an applied product or a set device of a final user's device including the LCM, the OLED module and the QD module as well as a display device in a narrow sense such as the LCM, the OLED module and the QD module.

According to circumstances, the LCM, the OLED module and the QD module having a display panel and a driving unit can be expressed as “a display device”, and an electronic apparatus of a complete product including the LCM, the OLED module and the QD module can be expressed as “a set device.” For example, a display device in a narrow sense can include a display panel of a liquid crystal, an organic light emitting diode and a quantum dot and a source printed circuit board (PCB) of a control unit for driving the display panel, and a set device can further include a set PCB of a set control unit electrically connected to the source PCB for controlling the entire set device.

The display panel of the present disclosure can include all kinds of display panels such as a liquid crystal display panel, an organic light emitting diode display panel, a quantum dot display panel and an electroluminescent display panel. The display panel of the present disclosure is not limited to a specific display panel of a bezel bending having a flexible substrate for an organic light emitting diode display panel and a lower back plate supporter. A shape or a size of the display panel for the display device of the present disclosure is not limited thereto.

For example, when the display panel is an organic light emitting diode display panel, the display panel can include a plurality of gate lines, a plurality of data lines and a subpixel in a crossing region of the plurality of gate lines and the plurality of data lines. The display panel can include an array having a thin film transistor of an element for selectively applying a voltage to each subpixel, an emitting element layer on the array and an encapsulating substrate or an encapsulation part covering the emitting element layer. The encapsulation part can protect the thin film transistor and the emitting element layer from an external impact and can prevent or at least reduce penetration of a moisture or oxygen into the emitting element layer. In addition, the emitting element layer on the array can include an inorganic light emitting layer, for example, a nano-sized material layer or a quantum dot.

The thin film transistor of the present disclosure can include one of an oxide thin film transistor, an amorphous silicon thin film transistor, and a low temperature polycrystalline silicon thin film transistor.

Features of various embodiments of the present disclosure can be partially or entirely coupled to or combined with each other. They can be linked and operated technically in various ways as those skilled in the art can sufficiently understand. The aspects can be carried out independently of or in association with each other in various combinations.

Hereinafter, a display device according to various example embodiments of the present disclosure where an influence on an oxide semiconductor layer of a thin film transistor of a driving element part is reduced by shielding a light emitted and transmitted from a subpixel and/or a light inputted from an exterior will be described in detail with reference to the accompanying drawings. All the components of each dual view display device/apparatus according to all embodiments of the present disclosure are operatively coupled and configured.

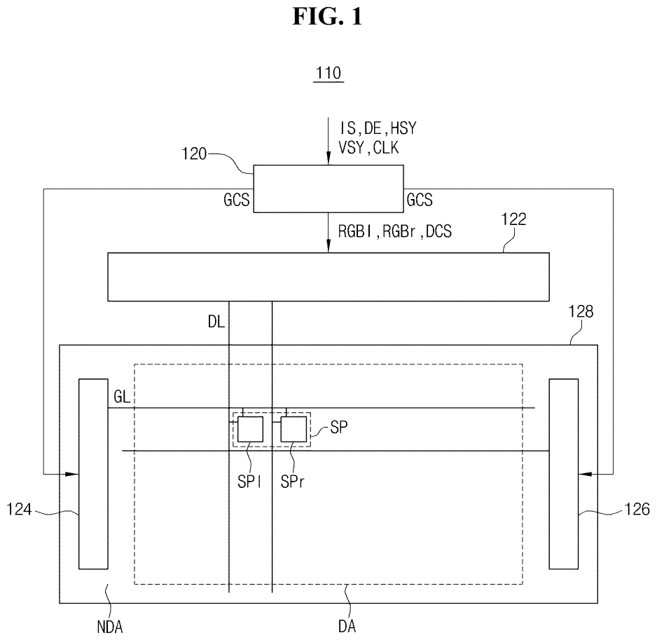

FIG. 1 is a view showing a dual view display device according to a first embodiment of the present disclosure. Although the display device can be an organic light emitting diode (OLED) display device, it is not limited thereto. For example, the display device can be a quantum dot (QD) display device, a micro light emitting diode (LED) display device or a mini light emitting diode (LED) display device. Further, although the terms such as “left” and “right” are used, e.g., ‘left image’ and ‘right image, ‘left subpixel’ and ‘right subpixel,’ etc. in the present disclosure, these features of the present disclosure are not limited to such positional/relational languages and can be represented as ‘first’ and ‘second’ (or vice versa), etc.

Referring to FIG. 1, a dual view display device 110 according to the first embodiment of the present disclosure includes a timing controlling unit 120 (e.g., a circuit), a data driving unit 122 (e.g., a circuit), first and second gate driving units 124 and 126 (e.g., circuits) and a display panel 128.

The timing controlling unit 120 generates a left image data RGBl, a right image data RGBr, a data control signal DCS and a gate control signal GCS using an image signal IS and a plurality of timing signals including a data enable signal DE, a horizontal synchronization signal HSY, a vertical synchronization signal VSY and a clock signal CLK transmitted from an external system such as a graphic card or a television system.

The timing controlling unit 120 transmits the left image data RGBl, the right image data RGBr and the data control signal DCS to the data driving unit 122 and transmits the gate control signal GCS to the first and second gate driving units 124 and 126.

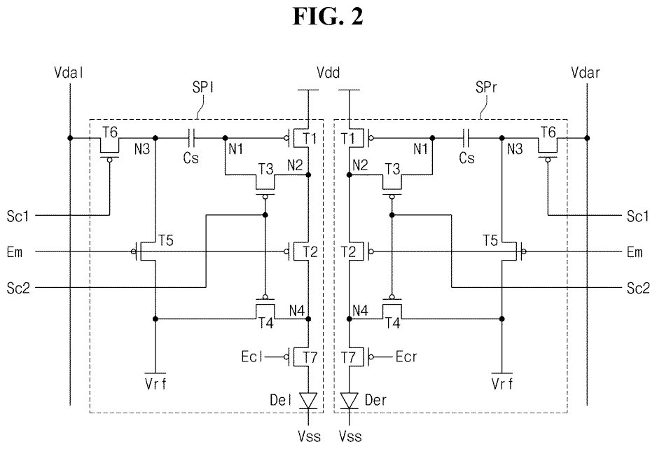

The data driving unit 122 generates a left data signal (a left data voltage) Vdal (of FIG. 2) and a right data signal (a right data voltage) Vdar (of FIG. 2) using the left image data RGBl, the right image data RGBr and the data control signal DCS transmitted from the timing controlling unit 120 and applies the left data signal Vdal and the right data signal Vdar to a data line DL of the display panel 128.

The first and second gate driving units 124 and 126 generate a gate signal (a gate voltage) Sc1, Sc2, Em, Ecl and Ecr (of FIG. 2) using the gate control signal GCS transmitted from the timing controlling unit 120 and applies the gate signal Sc1, Sc2, Em, Ecl and Ecr to a gate line GL of the display panel 128.

The first and second gate driving units 124 and 126 can have a gate in panel (GIP) type to be formed in a non-display area NDA of a substrate of the display panel 128 having the gate line GL, the data line DL and a pixel P.

Although the first and second gate driving units 124 and 126 are disposed in both side portions of the display panel 128 in the embodiment of FIG. 1, one gate driving unit can be disposed in one side portion of the display panel 128 in another embodiment of the present disclosure.

The display panel 128 includes a display area DA at a central portion thereof and a non-display area NDA surrounding the display area DA. The display panel 128 displays an image using the gate signal Sc1, Sc2, Em, Ecl and Ecr, the left data signal Vdal and the right data signal Vdar. For displaying an image, the display panel 128 includes a plurality of subpixels SP, a plurality of gate lines GL and a plurality of data lines DL in the display area DA.

The plurality of subpixels SP includes a left subpixel SPl for displaying the left image and a right subpixel SPr for displaying the right image. The gate line GL and the data line DL cross each other to define the left subpixel SPl and the right subpixel SPr. Each of the left subpixel SPl and the right subpixel SPr is connected to the gate line GL and the data line DL.

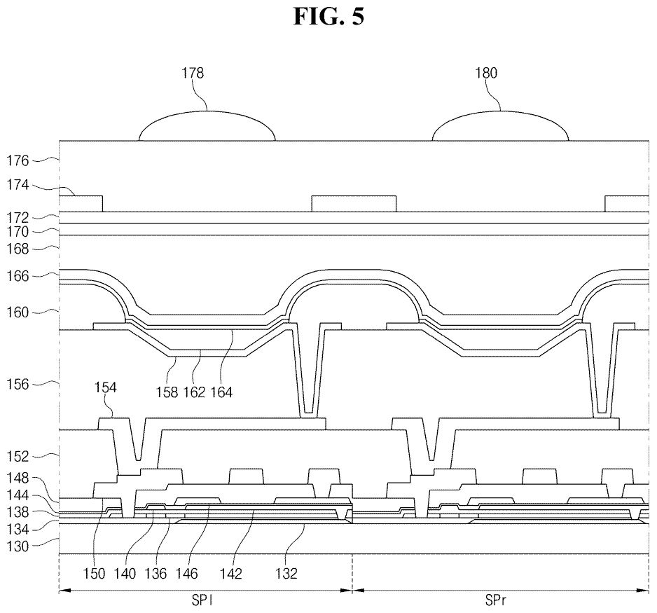

For example, a left lens 178 (of FIG. 5) of a hemispherical shape or a hemicylindrical shape that focuses a light along a left direction toward a front portion is disposed on the display panel 128 corresponding to the left subpixel SPl, and a right lens 180 (of FIG. 5) of a hemispherical shape or a hemicylindrical shape lens that focuses a light along a right direction toward a front portion is disposed on the display panel 128 corresponding to the right subpixel SPr.

Among the plurality of subpixels SP, some constituting a white color constitute one pixel.

For example, first, second and third subpixels corresponding to red, green and blue colors among the plurality of subpixels SP can constitute one pixel, or first, second, third and fourth subpixels corresponding to red, green, blue and white colors among the plurality of subpixels can constitute one pixel.

Each of the left subpixel SPl and the right subpixel SPr can include a plurality of transistors such as a switching transistor, a driving transistor and a sensing transistor, a storage capacitor and a light emitting diode.

In the dual view display device 110, the left data signal Vdal (of FIG. 2) corresponding to the left image data RGBl is applied to the left subpixel SPl of the display area DA of the display panel 128, and the right data signal Vdar (of FIG. 2) corresponding to the right image data RGBr is applied to the right subpixel SPr of the display area DA of the display panel 128.

As a result, the display panel 128 of the dual view display device 110 can display a left image corresponding to the left image data RGBl through the left subpixel SPl of the display area DA along the left direction, and the dual view display device 110 can display a right image corresponding to the right image data RGBr through the right subpixel SPr of the display area DA along the right direction.

Although the first and second gate driving units 124 and 126 generate the left emission control signal Ecl and the right emission control signal Ecr and supply the left emission control signal Ecl and the right emission control signal Ecr to the left subpixel SPl and the right subpixel SPr of the display panel 128 in the embodiment of FIG. 1, the timing controlling unit 120 can generate the left emission control signal Ecl and the right emission control signal Ecr and can supply the left emission control signal Ecl and the right emission control signal Ecr to the left subpixel SPl and the right subpixel SPr of the display panel 128 in the another embodiment of the present disclosure.

A structure and an operation of the left subpixel and the right subpixel of the dual view display device 110 according to the first embodiment of the present disclosure will be illustrated with reference to drawings.

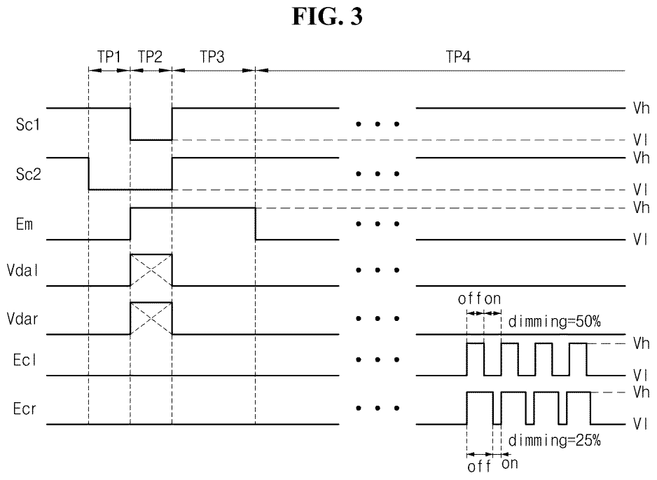

FIG. 2 is a circuit diagram showing a left subpixel and a right subpixel of a dual view display device according to the first embodiment of the present disclosure, and FIG. 3 is a view showing a plurality of signals of a left subpixel and a right subpixel of a dual view display device according to the first embodiment of the present disclosure.

Referring to FIG. 2, each left subpixel SPl and each right subpixel SPr in all subpixels of the display panel 128 of the dual view display device 110 according to the first embodiment of the present disclosure each includes first to seventh transistors T1 to T7, a storage capacitor Cs and one of a left light emitting diode Del and a right light emitting diode Der.

Although the first to seventh transistors T1 to T7 have a positive type in the embodiment of FIG. 2, at least one of the first to seventh transistors T1 to T7 can have a negative type in another embodiment of the present disclosure.

The first transistor T1 as a driving transistor is switched according to a voltage of a first node N1. A gate electrode of the first transistor T1 is connected to the first node N1, a source electrode of the first transistor T1 is connected to a high level signal (high level voltage) Vdd, and a drain electrode of the first transistor T1 is connected to a second node N2.

The second transistor T2 as an emitting transistor is switched according to an emission signal Em. A gate electrode of the second transistor T2 is connected to the emission signal Em, a source electrode of the second transistor T2 is connected to the second node N2, a drain electrode of the second transistor T2 is connected to a fourth node N4.

The third transistor T3 as a sensing transistor is switched according to a second scan signal Sc2. A gate electrode of the third transistor T3 is connected to the second scan signal Sc2, source electrode of the third transistor T3 is connected to the second node N2, and a drain electrode of the third transistor T3 is connected to the first node N1.

The fourth transistor T4 is switched according to the second scan signal Sc2. A gate electrode of the fourth transistor T4 is connected to the second scan signal Sc2, a source electrode of the fourth transistor T4 is connected to the fourth node N4, and a drain electrode of the fourth transistor T4 is connected to a reference signal (reference voltage) Vrf.

The fifth transistor T5 is switched according to the emission signal Em. A gate electrode of the fifth transistor T5 is connected to the emission signal Em, a source electrode of the fifth transistor T5 is connected to a third node N3, and a drain electrode of the fifth transistor T5 is connected to the reference signal Vrf.

The sixth transistor T6 as a switching transistor is switched according to a first scan signal Sc1. A gate electrode of the sixth transistor T6 is connected to the first scan signal Sc1, a source electrode of the sixth transistor T6 is connected to the third node N3, and a drain electrode of the sixth transistor T6 is connected to the left data signal Vdal or the right data signal Vdar.

The seventh transistor T7 as an emitting transistor is switched according to a left emission control signal Ecl or a right emission control signal Ecr. A gate electrode of the seventh transistor T7 is connected to the left emission control signal Ecl or the right emission control signal Ecr, a source electrode of the seventh transistor T7 is connected to the fourth node N4, and a drain electrode of the seventh transistor T7 is connected to an anode of a left light emitting diode Del or an anode of a right light emitting diode Der.

The storage capacitor Cs stores the left data signal Vdal or the right data signal Vdar and a threshold voltage (Vth) of the first transistor T1. A first capacitor electrode of the storage capacitor Cs is connected to the first node N1, and a second capacitor electrode of the storage capacitor Cs is connected to the third node N3.

Each of the left light emitting diode Del and the right light emitting diode Der is connected between the seventh transistor T7 and a low level signal (low level voltage) Vss and emits a light of a luminance proportional to a current of the first transistor T1. An anode of each of the left light emitting diode Del and the right light emitting diode Der is connected to the drain electrode of the seventh transistor T7, and a cathode of the left light emitting diode Del and the right light emitting diode Der is connected to the low level signal Vss.

A left lens 178 (of FIG. 5) of a hemispherical shape or a hemicylindrical shape focusing a light along a left direction toward a front portion is disposed on the left light emitting diode Del of the left subpixel SPl to display the left image to a user, and a right lens 180 (of FIG. 5) of a hemispherical shape or a hemicylindrical shape focusing a light along a right direction toward a front portion is disposed on the right light emitting diode Der of the right subpixel SPr to display the right image to a user.

The gate electrode of the first transistor T1, the first capacitor electrode of the storage capacitor Cs and the drain electrode of the third transistor T3 constitute the first node N1, and the drain electrode of the first transistor T1, the source electrode of the second transistor T2 and the source electrode of the third transistor T3 constitute the second node N2. The second capacitor electrode of the storage capacitor Cs, the source electrode of the fifth transistor T5 and the source electrode of the sixth transistor T6 constitute the third node, and the drain electrode of the second transistor T2, the source electrode of the fourth transistor T4 and the source electrode of the seventh transistor T7 constitute the fourth node N4.

In the dual view display device 110 according to the first embodiment of the present disclosure, the seventh transistor T7 of the left subpixel SPl is switched according to the left emission control signal Ecl to drive the left light emitting diode Del with a dimming method and to adjust a luminance of the left image. Further, the seventh transistor T7 of the right subpixel SPr is switched according to the right emission control signal Ecr to drive the right light emitting diode Der with a dimming method and to adjust a luminance of the right image.

As a result, the luminances of the left image and the right image are independently adjusted by independently driving the left light emitting diode Del and the right light emitting diode Der with a dimming method.

Referring to FIG. 3, each of the left subpixel SPl and the right subpixel SPr of the dual view display device 110 according to the first embodiment of the present disclosure is driven through first to fourth periods TP1 to TP4.

During the first period TP1 as an initialization period, the second, third, fourth, fifth and seventh transistors T2, T3, T4, T5 and T7 are turned on due to (e.g., in response to) the second scan signal Sc2, the emission signal Em, the left emission control signal Ecl and the right emission control signal Ecr of a logic low voltage Vl, and the sixth transistor T6 is turned off due to (e.g., in response to) the first scan signal Sc1 of a logic high voltage Vh. Since the reference signal Vrf is applied to the first, second, third and fourth nodes N1, N2, N3 and N4, the first and second capacitor electrodes of the storage capacitor Cs, the gate electrode of the first transistor T1, the anode of the left light emitting diode Del and the anode of the right light emitting diode Der are initialized by the reference signal Vrf.

During the second period TP2 as a sampling period, the third, fourth, sixth and seventh transistors T3, T4, T6 and T7 are turned on due to (e.g., in response to) the first scan signal Sc1, the second scan signal Sc2, the left emission control signal Ecl and the right emission control signal Ecr of a logic low voltage Vl, and the second and fifth transistors T2 and T5 are turned off due to (e.g., in response to) the emission signal Em of a logic high voltage Vh. The left data signal Vdal or the right data signal Vdar is applied to the third node N3, the high level signal Vdd is applied to the first node N1, and the reference signal Vrf is applied to the fourth node N4. As a result, the second capacitor electrode of the storage capacitor Cs has the left data signal Vdal or the right data signal Vdar, and the first capacitor electrode of the storage capacitor Cs has a sum of a difference between the left data signal Vdal and the reference signal Vrf and the threshold voltage Vth (Vdal−Vrf+Vth) or a difference between the right data signal Vdar and the reference signal Vrf and the threshold voltage Vth (Vdar−Vrf+Vth). Accordingly, the threshold voltage Vth is stored in the storage capacitor Cs, and the anode of the left light emitting diode Del and the anode of the right light emitting diode Der are kept as the reference signal Vrf.

During the third period TP3 as a holding period, the second, third, fourth, fifth and sixth transistors T2, T3, T4, T5 and T6 are turned off due to (e.g., in response to) the first scan signal Sc1, the second scan signal Sc2 and the emission signal Em of a logic high voltage Vh, and the seventh transistor T7 is turned on due to (e.g., in response to) the left emission control signal Ecl and the right emission control signal Ecr of a logic low voltage Vl. As a result, the second capacitor electrode of the storage capacitor Cs is kept as the left data signal Vdal or the right data signal Vdar, and the first capacitor electrode of the storage capacitor Cs is kept as a sum of a difference between the left data signal Vdal and the reference signal Vrf and the threshold voltage Vth (Vdal−Vrf+Vth) or a difference between the right data signal Vdar and the reference signal Vrf and the threshold voltage Vth (Vdar−Vrf+Vth). Further, the anode of the left light emitting diode Del and the anode of the right light emitting diode Der are kept as the reference signal Vrf.

During the fourth period TP4 as an emission period, the second, fifth and seventh transistors T2, T5 and T7 are turned on due to (e.g., in response to) the emission signal Em, the left emission control signal Ecl and the right emission control signal Ecr of a logic low voltage Vl, and the third, fourth and sixth transistors T3, T4 and T6 are turned off due to (e.g., in response to) the first scan signal Sc1 and the second scan signal Sc2 of a logic high voltage Vh. The reference signal Vrf is applied to the third node N3. As a result, a current proportional to a square of a value ((Vdal−Vrf+Vth−Vdd)−Vth=Vdal−Vrf−Vdd or (Vdar−Vrf+Vth−Vdd)−Vth=Vdar−Vrf−Vdd) obtained by subtracting the threshold voltage Vth from a gate-source voltage Vgs flows through the first transistor T1, and the left light emitting diode Del and the right light emitting diode Der emit a light of a luminance corresponding to the current flowing through the first transistor T1.

An off section corresponding to the logic high voltage Vh of the left emission control signal Ecl and the right emission control signal Ecr can be defined as a portion of the fourth period TP4, a width of the off section of the left emission control signal Ecl and a width of the off section of the right emission control signal Ecm can be independently changed, and a luminance of a light emitted from the left light emitting diode Del and a luminance of a light emitted from the right light emitting diode Der can be independently adjusted by changing widths of the off sections independently.

For example, a duty ratio can be defined as a ratio of an on section with respect to a sum of the off section and the on section, and a luminance of the left image due to the left subpixel SPl can be adjusted to be twice of a luminance of the right image due to the right subpixel SPr by determining the duty ratios of the left emission control signal Ecl and the right emission control signal Ecr as about 50% and about 25%, respectively.

Although each of the left subpixel SPl and the right subpixel SPr has a 7T1C structure having seven transistors and one storage capacitor in the embodiment of FIG. 2, each of the left subpixel SPl and the right subpixel SPr can have one of a 4T1C structure having four transistors and one storage capacitor, a 8T1C structure having eight transistors and one storage capacitor and a 9T1C structure having nine transistors and one storage capacitor in another embodiment of the present disclosure.

A plan structure and a cross-sectional structure of the left subpixel SPl and the right subpixel SPr of the dual view display device 110 according to the first embodiment of the present disclosure will be illustrated with reference to drawings.

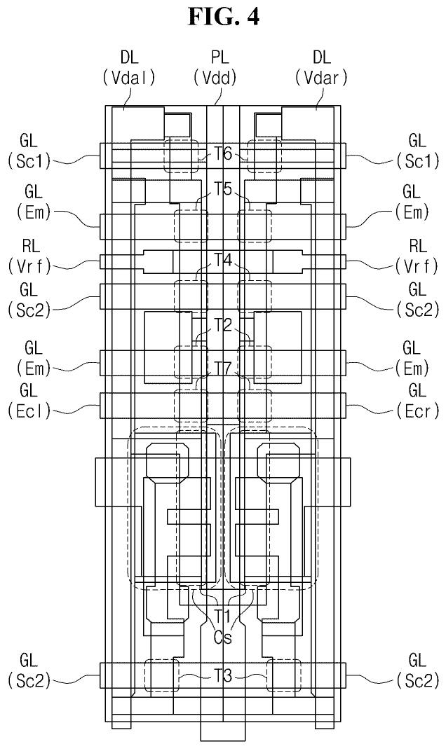

FIG. 4 is a plan view showing a left subpixel and a right subpixel of a dual view display device according to the first embodiment of the present disclosure, and FIG. 5 is a cross-sectional view showing a left subpixel and a right subpixel of a dual view display device according to the first embodiment of the present disclosure.

Referring to FIG. 4, the gate line GL transmitting the first scan signal Sc1, the gate line GL transmitting the emission signal Em, the gate line GL transmitting the second scan signal Sc2, a reference line RL transmitting the reference signal Vrf and the gate line GL transmitting the second scan signal Sc2 are sequentially disposed along a horizontal direction, and a power line PL transmitting the high level signal Vdd is disposed along a vertical direction in each of the left subpixel SPl and the right subpixel SPr of the dual view display device 110 according to the first embodiment of the present disclosure.

The first transistor T1 is connected to the power line PL, the second and fifth transistors T2 and T5 are connected to the gate line GL transmitting the emission signal Em, and the third and fourth transistors T3 and T4 are connected to the gate line GL transmitting the second scan signal Sc2.

The sixth transistor T6 of the left subpixel SPl is connected to the gate line transmitting the first scan signal Sc1 and the data line DL transmitting the left data signal Vdal, and the sixth transistor T6 of the right subpixel SPr is connected to the gate line GL transmitting the first scan signal Sc1 and the data line DL transmitting the right data signal Vdar.

The seventh transistor T7 of the left subpixel SPl is connected to the gate line GL transmitting the left emission control signal Ecl, and the seventh transistor T7 of the right subpixel SPr is connected to the gate line transmitting the right emission control signal Ecr.

Referring to FIG. 5, a light shielding pattern 132 is disposed in each of the left subpixel SPl and the right subpixel SPr on the substrate 130, and a first buffer layer 134 is disposed on the light shielding pattern 132 over the entire substrate 130.

The light shielding pattern 132 can block a light incident from a lower portion of the substrate 130. For example, the light shielding pattern 132 can have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

The first buffer layer 134 can block a moisture or an oxygen permeating from an exterior. For example, the first buffer layer 134 can have a single layer or a multiple layer of an inorganic insulating material such as silicon oxide (SiO₂) and silicon nitride (SiNx).

A semiconductor layer 136 is disposed on the first buffer layer 134 corresponding to the light shielding pattern 132 in each of the left subpixel SPl and the right subpixel SPr, and a gate insulating layer 138 is disposed on the semiconductor layer 136 over the entire substrate 130.

The semiconductor layer 136 includes a channel region not doped with an impurity at a central portion thereof and source and drain regions doped with an impurity at both side portions of the channel region. For example, the semiconductor layer 136 can include a polycrystalline semiconductor material such as polycrystalline silicon or an oxide semiconductor material such as indium gallium zinc oxide (IGZO), zinc oxide (ZnO), tin oxide (SnO₂), copper oxide (Cu₂O), nickel oxide (NiO), indium tin zinc oxide (ITZO) and indium aluminum zinc oxide (IAZO).

For example, the gate insulating layer 138 can have a single layer or a multiple layer of an inorganic insulating material such as silicon oxide (SiO₂) and silicon nitride (SiNx).

A gate electrode 140 is disposed on the gate insulating layer 138 corresponding to the channel region of the semiconductor layer 136 in each of the left subpixel SPl and the right subpixel SPr, a first capacitor electrode 142 separated from the gate electrode 140 is disposed on the gate insulating layer 138 in each of the left subpixel SPl and the right subpixel SPr, and a first interlayer insulating layer 144 is disposed on the gate electrode 140 and the first capacitor electrode 142 over the entire substrate 130.

The first capacitor electrode 142 can be connected to the light shielding pattern 132 through a contact hole in the gate insulating layer 138 and the first buffer layer 134.

The gate electrode 140 and the first capacitor electrode 142 can have the same layer and the same material as each other. For example, the gate electrode 140 and the first capacitor electrode 142 can have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

For example, the first interlayer insulating layer 144 can have a single layer or a multiple layer of an inorganic insulating material such as silicon oxide (SiO₂) and silicon nitride (SiNx).

A second capacitor electrode 146 is disposed on the first interlayer insulating layer 144 corresponding to the first capacitor electrode 142 in each of the left subpixel SPl and the right subpixel SPr, and a second interlayer insulating layer 148 is disposed on the second capacitor electrode 146 over the entire substrate 130.

For example, the second capacitor electrode 146 can have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

The first capacitor electrode 142, the first interlayer insulating layer 144 and the second capacitor electrode 146 can constitute the storage capacitor Cs.

A source electrode and a drain electrode 150 spaced apart from each other are disposed on the second interlayer insulating layer 148 in each of the left subpixel SPl and the right subpixel SPr, and a first planarizing layer 152 is disposed on the source electrode and the drain electrode 150 over the entire substrate 130.

The source electrode and the drain electrode 150 are connected to the source region and the drain region, respectively, of the semiconductor layer 136 through contact holes in the second interlayer insulating layer 148, the first interlayer insulating layer 144 and the gate insulating layer 138.

The source electrode and the drain electrode 150 can have the same layer and the same material as each other. For example, the source electrode and the drain electrode 150 can have a single layer or a multiple layer of a metallic material such as molybdenum (Mo), aluminum (Al), chromium (Cr), gold (Au), titanium (Ti), nickel (Ni), neodymium (Nd), copper (Cu) and an alloy thereof.

For example, the first planarizing layer 152 can have a single layer or a multiple layer of an organic insulating material such as photoacryl and benzocyclobutene (BCB).

The semiconductor layer 136, the gate electrode 140, the source electrode and the drain electrode 150 can constitute the seventh transistor T7.

A connecting electrode 154 is disposed on the first planarizing layer 152 corresponding to the drain electrode 150 in each of the left subpixel SPl and the right subpixel SPr, and a second planarizing layer 156 is disposed on the connecting electrode 154 over the entire substrate 130.

The connecting electrode 154 is connected to the drain electrode 150 through a contact hole in the first planarizing layer 152.

For example, the connecting electrode 154 can have a triple layer of a metallic material such as aluminum (Al) and titanium (Ti).

For example, the second planarizing layer 156 can have a single layer or a multiple layer of an organic insulating material such as photoacryl and benzocyclobutene (BCB).

A first electrode 158 is disposed on the second planarizing layer 156 corresponding to the connecting electrode 154 in each of the left subpixel SPl and the right subpixel SPr, and a bank layer 160 is disposed on the first electrode 158 in each of the left subpixel SPl and the right subpixel SPr.

For example, a groove can be formed in a top surface of the second planarizing layer 156 in each of the left subpixel SPl and the right subpixel SPr, and the first electrode 158 can be disposed in the groove of the second planarizing layer 156.

The first electrode 158 is connected to the connecting electrode 154 through a contact hole in the second planarizing layer 156.

For example, the first electrode 158 can be an anode and can have a single layer or a multiple layer of a transparent conductive material such as indium tin oxide (ITO) and indium zinc oxide (IZO) or an opaque metallic material such as aluminum (Al), silver (Ag), copper (Cu), lead (Pb), molybdenum (Mo), titanium (Ti) and an alloy thereof.

The bank layer 160 covers an edge portion of the first electrode 158 and has an opening exposing a central portion of the first electrode 158.

For example, the bank layer 160 can have a single layer or a multiple layer of an organic insulating material such as photoacryl and benzocyclobutene (BCB).

An emitting layer 162 is disposed on the first electrode 158 exposed through the opening of the bank layer 160 in each of the left subpixel SPl and the right subpixel SPr, and a second electrode 164 is disposed on the emitting layer 162 over the entire substrate 130.

For example, the emitting layer 162 can be disposed in the groove of the second planarizing layer 156 such that a top surface of the emitting layer 162 is flush with a top surface of the second planarizing layer 156.

The emitting layer 162 can include a hole assisting layer such as a hole injecting layer and a hole transporting layer, an emitting material layer and an electron assisting layer such as an electron transporting layer and an electron injecting layer.

For example, the second electrode 164 can be a cathode and can have a single layer or a multiple layer of a transparent conductive material such as indium tin oxide (ITO) and indium zinc oxide (IZO) or a half-transmissive or opaque metallic material such as aluminum (Al), silver (Ag), copper (Cu), lead (Pb), magnesium (Mg), molybdenum (Mo), titanium (Ti) and an alloy thereof.

The first electrode 158, the emitting layer 162 and the second electrode 164 of the left subpixel SPl and the right subpixel SPr can constitute the left light emitting diode Del and the right light emitting diode Der, respectively.

A first encapsulating layer 166, a second encapsulating layer 168 and a third encapsulating layer 170 are sequentially disposed on the second electrode 164 over the entire substrate 130. The first encapsulating layer 166, the second encapsulating layer 168 and the third encapsulating layer 170 constitute an encapsulating layer preventing a permeation of a moisture.

For example, the first encapsulating layer 166 and the third encapsulating layer 170 can have a single layer or a multiple layer of an inorganic insulating material such as silicon oxide (SiO₂) and silicon nitride (SiNx), and the second encapsulating layer 168 can include an organic insulating material such as an acryl resin, an epoxy resin, a phenolic resin, a polyamide resin and a polyimide resin.

A second buffer layer 172 is disposed on the third encapsulating layer 170 over the entire substrate 130, and a black matrix 174 is disposed on the second buffer layer 172 in an edge portion of each of the left subpixel SPl and the right subpixel SPr.

The second buffer layer 172 can block a moisture or an oxygen permeating from an exterior. For example, the second buffer layer 172 can have a single layer or a multiple layer of an inorganic insulating material such as silicon oxide (SiO₂) and silicon nitride (SiNx).

The black matrix 174 can prevent an interference between lights emitted from the emitting layers 162 of the left subpixel SPl and the right subpixel SPr. For example, the black matrix 174 can include an organic insulating material such as a black resin.

A third interlayer insulating layer 176 is disposed on the black matrix 174 over the entire substrate 130, and a left lens 178 and a right lens 180 are disposed on the third interlayer insulating layer 176 in the left subpixel SPl and the right subpixel SPr, respectively.

For example, the third interlayer insulating layer 176 can have a single layer or a multiple layer of an inorganic insulating material such as silicon oxide (SiO₂) and silicon nitride (SiNx) or an organic insulating material such as photoacryl and benzocyclobutene (BCB).

The left lens 178 can focus a light emitted from the emitting layer 162 of the left subpixel SPl along a left direction, and the right lens 180 can focus a light emitted from the emitting layer 162 of the right subpixel SPr along a right direction.

A third planarizing layer having a single layer or a multiple layer of an organic insulating material such as photoacryl and benzocyclobutene (BCB) can be disposed on the left lens 178 and the right lens 180 over the entire substrate 130.

In the dual view display device 110 according to the first embodiment of the present disclosure, the seventh transistor T7 is disposed in each of the left subpixel SPl displaying the left image and the right subpixel SPr displaying the right image. The seventh transistor T7 of the left subpixel SPl and the seventh transistor T7 of the right subpixel SPr are switched according to the left emission control signal Ecl and the right emission control signal Ecr, respectively, which are independent from each other. As a result, the luminances of the left image and the right image are independently adjusted and the low power consumption is obtained by driving the left light emitting diode Del and the right light emitting diode Der through a dimming method with the independent duty ratios.

In another embodiment of the present disclosure, the emitting transistors can be switched according to independent emission signals.

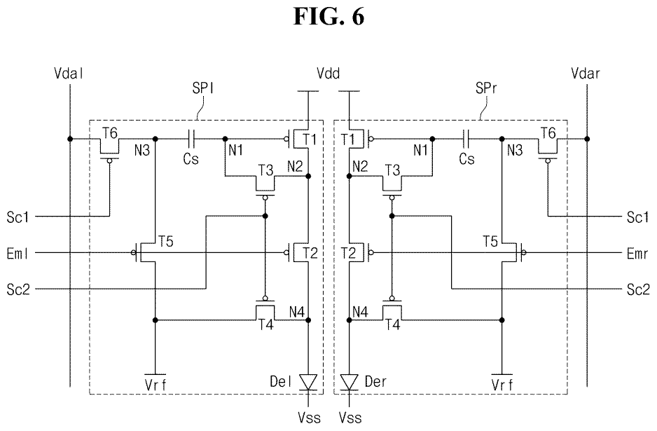

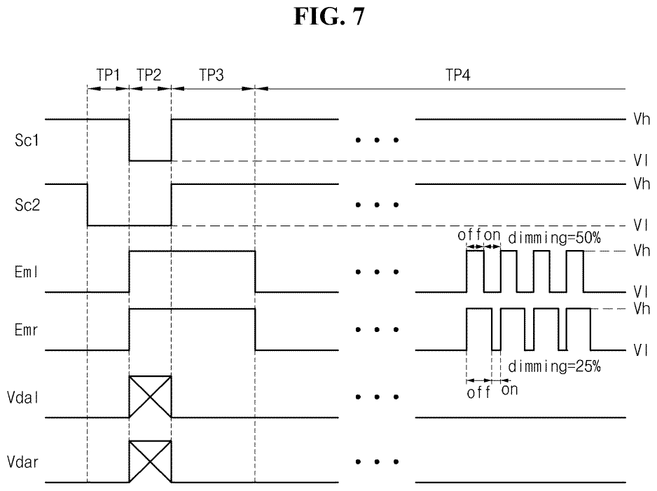

FIG. 6 is a circuit diagram showing a left subpixel and a right subpixel of a dual view display device according to a second embodiment of the present disclosure, and FIG. 7 is a view showing a plurality of signals of a left subpixel and a right subpixel of a dual view display device according to the second embodiment of the present disclosure.

Referring to FIG. 6, each left subpixel SPl and each right subpixel SPr in all subpixels of a display panel of a dual view display device according to the second embodiment of the present disclosure each includes first to sixth transistors T1 to T6, a storage capacitor Cs and one of a left light emitting diode Del and a right light emitting diode Der.

Although the first to sixth transistors T1 to T6 have a positive type in the embodiment of FIG. 6, at least one of the first to sixth transistors T1 to T6 can have a negative type in another embodiment of the present disclosure.

The first transistor T1 as a driving transistor is switched according to a voltage of a first node N1. A gate electrode of the first transistor T1 is connected to the first node N1, a source electrode of the first transistor T1 is connected to a high level signal (high level voltage) Vdd, and a drain electrode of the first transistor T1 is connected to a second node N2.

The second transistor T2 as an emitting transistor is switched according to a left emission signal Eml or a right emission signal Emr. A gate electrode of the second transistor T2 is connected to the left emission signal Eml or the right emission signal Emr, a source electrode of the second transistor T2 is connected to the second node N2, a drain electrode of the second transistor T2 is connected to a fourth node N4.

The third transistor T3 as a sensing transistor is switched according to a second scan signal Sc2. A gate electrode of the third transistor T3 is connected to the second scan signal Sc2, source electrode of the third transistor T3 is connected to the second node N2, and a drain electrode of the third transistor T3 is connected to the first node N1.

The fourth transistor T4 is switched according to the second scan signal Sc2. A gate electrode of the fourth transistor T4 is connected to the second scan signal Sc2, a source electrode of the fourth transistor T4 is connected to the fourth node N4, and a drain electrode of the fourth transistor T4 is connected to a reference signal (reference voltage) Vrf.

The fifth transistor T5 is switched according to the left emission signal Eml or the right emission signal Emr. A gate electrode of the fifth transistor T5 is connected to the left emission signal Eml or the right emission signal Emr, a source electrode of the fifth transistor T5 is connected to a third node N3, and a drain electrode of the fifth transistor T6 is connected to the reference signal Vrf.

The sixth transistor T6 as a switching transistor is switched according to a first scan signal Sc1. A gate electrode of the sixth transistor T6 is connected to the first scan signal Sc1, a source electrode of the sixth transistor T6 is connected to the third node N3, and a drain electrode of the sixth transistor T6 is connected to the left data signal Vdal or the right data signal Vdar.

The storage capacitor Cs stores the left data signal Vdal or the right data signal Vdar and a threshold voltage (Vth) of the first transistor T1. A first capacitor electrode of the storage capacitor Cs is connected to the first node N1, and a second capacitor electrode of the storage capacitor Cs is connected to the third node N3.

Each of the left light emitting diode Del and the right light emitting diode Der is connected between the second and fourth transistors T2 and T4 and a low level signal (low level voltage) Vss and emits a light of a luminance proportional to a current of the first transistor T1. An anode of each of the left light emitting diode Del and the right light emitting diode Der is connected to the fourth node N4, and a cathode of the left light emitting diode Del and the right light emitting diode Der is connected to the low level signal Vss.

A left lens 178 (of FIG. 5) of a hemispherical shape or a hemicylindrical shape focusing a light along a left direction toward a front portion is disposed on the left light emitting diode Del of the left subpixel SPl to display the left image to a user, and a right lens 180 (of FIG. 5) of a hemispherical shape or a hemicylindrical shape focusing a light along a right direction toward a front portion is disposed on the right light emitting diode Der of the right subpixel SPr to display the right image to a user.

The gate electrode of the first transistor T1, the first capacitor electrode of the storage capacitor Cs and the drain electrode of the third transistor T3 constitute the first node N1, and the drain electrode of the first transistor T1, the source electrode of the second transistor T2 and the source electrode of the third transistor T3 constitute the second node N2. The second capacitor electrode of the storage capacitor Cs, the source electrode of the fifth transistor T5 and the source electrode of the sixth transistor T6 constitute the third node N3, and the drain electrode of the second transistor T2 and the anode of the left light emitting diode Del or the right light emitting diode Der constitute the fourth node N4.

In the dual view display device according to the second embodiment of the present disclosure, the second transistor T2 of the left subpixel SPl is switched according to the left emission signal Eml to drive the left light emitting diode Del with a dimming method and to adjust a luminance of the left image. Further, the second transistor T2 of the right subpixel SPr is switched according to the right emission signal Emr to drive the right light emitting diode Der with a dimming method and to adjust a luminance of the right image.

As a result, according to aspects of the present disclosure, the luminances of the left image and the right image are independently adjusted by independently driving the left light emitting diode Del and the right light emitting diode Der with a dimming method.

Referring to FIG. 7, each of the left subpixel SPl and the right subpixel SPr of the dual view display device according to the second embodiment of the present disclosure is driven through first to fourth periods TP1 to TP4.

During the first period TP1 as an initialization period, the second, third, fourth and fifth transistors T2, T3, T4 and T5 are turned on due to (e.g., in response to) the second scan signal Sc2, the left emission signal Eml and the right emission signal Emr of a logic low voltage Vl, and the sixth transistor T6 is turned off due to (e.g., in response to) the first scan signal Sc1 of a logic high voltage Vh. Since the reference signal Vrf is applied to the first, second, third and fourth nodes N1, N2, N3 and N4, the first and second capacitor electrodes of the storage capacitor Cs, the gate electrode of the first transistor T1, the anode of the left light emitting diode Del and the anode of the right light emitting diode Der are initialized by the reference signal Vrf.

During the second period TP2 as a sampling period, the third, fourth and sixth transistors T3, T4 and T6 are turned on due to (e.g., in response to) the first scan signal Sc1 and the second scan signal Sc2 of a logic low voltage Vl, and the second and fifth transistors T2 and T5 are turned off due to (e.g., in response to) the left emission signal Eml and the right emission signal Emr of a logic high voltage Vh. The left data signal Vdal or the right data signal Vdar is applied to the third node N3, the high level signal Vdd is applied to the first node N1, and the reference signal Vrf is applied to the fourth node N4. As a result, the second capacitor electrode of the storage capacitor Cs has the left data signal Vdal or the right data signal Vdar, and the first capacitor electrode of the storage capacitor Cs has a sum of a difference between the left data signal Vdal and the reference signal Vrf and the threshold voltage Vth (Vdal−Vrf+Vth) or a difference between the right data signal Vdar and the reference signal Vrf and the threshold voltage Vth (Vdar−Vrf+Vth). Accordingly, the threshold voltage Vth is stored in the storage capacitor Cs, and the anode of the left light emitting diode Del and the anode of the right light emitting diode Der are kept as the reference signal Vrf.

During the third period TP3 as a holding period, the second, third, fourth, fifth and sixth transistors T2, T3, T4, T5 and T6 are turned off due to (e.g., in response to) the first scan signal Sc1, the second scan signal Sc2, the left emission signal Eml and the right emission signal Emr of a logic high voltage Vh. As a result, the second capacitor electrode of the storage capacitor Cs is kept as the left data signal Vdal or the right data signal Vdar, and the first capacitor electrode of the storage capacitor Cs is kept as a sum of a difference between the left data signal Vdal and the reference signal Vrf and the threshold voltage Vth (Vdal−Vrf+Vth) or a difference between the right data signal Vdar and the reference signal Vrf and the threshold voltage Vth (Vdar−Vrf+Vth). Further, the anode of the left light emitting diode Del and the anode of the right light emitting diode Der are kept as the reference signal Vrf.

During the fourth period TP4 as an emission period, the second and fifth transistors T2 and T5 are turned on due to (e.g., in response to) the left emission signal Eml and the right emission signal Emr of a logic low voltage Vl, and the third, fourth and sixth transistors T3, T4 and T6 are turned off due to (e.g., in response to) the first scan signal Sc1 and the second scan signal Sc2 of a logic high voltage Vh. The reference signal Vrf is applied to the third node N3. As a result, a current proportional to a square of a value ((Vdal−Vrf+Vth−Vdd)−Vth=Vdal−Vrf−Vdd or (Vdar−Vrf+Vth−Vdd)−Vth=Vdar−Vrf−Vdd) obtained by subtracting the threshold voltage Vth from a gate-source voltage Vgs flows through the first transistor T1, and the left light emitting diode Del and the right light emitting diode Der emit a light of a luminance corresponding to the current flowing through the first transistor T1.

An off section corresponding to the logic high voltage Vh of the left emission signal Eml and the right emission signal Emr can be defined as a portion of the fourth period TP4, a width of the off section of the left emission signal Eml and a width of the off section of the right emission signal Emr can be independently changed, and a luminance of a light emitted from the left light emitting diode Del and a luminance of a light emitted from the right light emitting diode Der can be independently adjusted by changing widths of the off sections independently.

For example, a duty ratio can be defined as a ratio of an on section with respect to a sum of the off section and the on section, and a luminance of the left image due to the left subpixel SPl can be adjusted to be twice of a luminance of the right image due to the right subpixel SPr by determining the duty ratios of the left emission signal Eml and the right emission signal Emr as about 50% and about 25%, respectively.

Although each of the left subpixel SPl and the right subpixel SPr has a 6T1C structure having six transistors and one storage capacitor in the embodiment of FIG. 6, each of the left subpixel SPl and the right subpixel SPr can have one of a 3T1C structure having three transistors and one storage capacitor, a 7T1C structure having seven transistors and one storage capacitor and a 8T1C structure having eight transistors and one storage capacitor in another embodiment of the present disclosure.

In the dual view display device according to the second embodiment of the present disclosure, the second transistor T2 of the left subpixel SPl displaying the left image and the second transistor T2 of the right subpixel SPr displaying the right image are switched according to the left emission signal Eml and the right emission signal Emr, respectively, which are independent from each other. As a result, the luminances of the left image and the right image are independently adjusted and the low power consumption is obtained by driving the left light emitting diode Del and the right light emitting diode Der through a dimming method with the independent duty ratios.

It will be apparent to those skilled in the art that various modifications and variation can be made in the present disclosure without departing from the scope of the disclosure. Thus, it is intended that the present disclosure cover the modifications and variations of this disclosure provided they come within the scope of the appended claims and their equivalents.

What is claimed is:

1. A dual view display device, comprising:
a display panel including a display area having a left subpixel and a right subpixel and a non-display area at a periphery of the display area;
a first transistor in each of the left subpixel and the right subpixel, the first transistor switched according to a voltage of a first node and connected to a high level signal and a second node;
a second transistor in each of the left subpixel and the right subpixel, the second transistor switched according to an emission signal and connected to the second node and a fourth node;
a third transistor in each of the left subpixel and the right subpixel, the third transistor switched according to a second scan signal and connected to the first node and the second node;
a fourth transistor in each of the left subpixel and the right subpixel, the fourth transistor switched according to the second scan signal and connected to the fourth node;
a fifth transistor in each of the left subpixel and the right subpixel, the fifth transistor switched according to the emission signal and connected to a third node and a reference signal;
a sixth transistor in each of the left subpixel and the right subpixel, the sixth transistor switched according to a first scan signal and connected to the third node; and
a seventh transistor in each of the left subpixel and the right subpixel, the seventh transistor connected to the fourth node,
wherein the seventh transistor of the left subpixel and the seventh transistor of the right subpixel are switched according to a left emission control signal and a right emission control signal, respectively.

2. The dual view display device of claim 1, further comprising:
a storage capacitor in each of the left subpixel and the right subpixel, the storage capacitor connected between the first and third nodes; and
a left light emitting diode and a right light emitting diode in the left subpixel and the right subpixel, respectively, each of the left light emitting diode and the right light emitting diode connected between the seventh transistor and a low level signal.

3. The dual view display device of claim 2, wherein a gate electrode of the first transistor, a first capacitor electrode of the storage capacitor and a drain electrode of the third transistor constitute the first node, and
wherein a drain electrode of the first transistor, a source electrode of the second transistor and a source electrode of the third transistor constitute the second node.

4. The dual view display device of claim 3, wherein a second capacitor electrode of the storage capacitor, a source electrode of the fifth transistor and a source electrode of the sixth transistor constitute the third node, and
wherein a drain electrode of the second transistor, a source electrode of the fourth transistor and a source electrode of the seventh transistor constitute the fourth node.

5. The dual view display device of claim 1, wherein, during a first period,
the second, third, fourth, fifth and seventh transistors are turned on in response to the second scan signal, the emission signal, the left emission control signal and the right emission control signal of a logic low voltage, and
the sixth transistor is turned off in response to the first scan signal of a logic high voltage.

6. The dual view display device of claim 5, wherein, during a second period,
the third, fourth, sixth and seventh transistors are turned on in response to the first scan signal, the second scan signal, the left emission control signal and the right emission control signal of a logic low voltage, and
the second and fifth transistors are turned off in response to the emission signal of a logic high voltage.

7. The dual view display device of claim 6, wherein, during a third period,
the second, third, fourth, fifth and sixth transistors are turned off in response to the first scan signal, the second scan signal and the emission signal of a logic high voltage, and
the seventh transistor is turned on in response to the left emission control signal and the right emission control signal of a logic low voltage.

8. The dual view display device of claim 7, wherein, during a fourth period,
the second, fifth and seventh transistors are turned on in response to the emission signal, the left emission control signal and the right emission control signal of a logic low voltage, and
the third, fourth and sixth transistors are turned off in response to the first scan signal and the second scan signal of a logic high voltage.

9. The dual view display device of claim 8, wherein the fourth period includes an off section corresponding to the logic high voltage of the left emission control signal and the right emission control signal, and
wherein a width of the off section of the left emission control signal and a width of the off section of the right emission control signal are independently changed.

10. A dual view display device, comprising:
a display panel including a display area having a left subpixel and a right subpixel and a non-display area at a periphery of the display area;
a first transistor in each of the left subpixel and the right subpixel, the first transistor switched according to a voltage of a first node and connected to a high level signal and a second node;
a second transistor in each of the left subpixel and the right subpixel, the second transistor connected to the second node and a fourth node;
a third transistor in each of the left subpixel and the right subpixel, the third transistor switched according to a second scan signal and connected to the first node and the second node;
a fourth transistor in each of the left subpixel and the right subpixel, the fourth transistor switched according to the second scan signal and connected to the fourth node;
a fifth transistor in each of the left subpixel and the right subpixel, the fifth transistor connected to a third node and a reference signal; and
a sixth transistor in each of the left subpixel and the right subpixel, the sixth transistor switched according to a first scan signal and connected to the third node,
wherein the second transistor of the left subpixel and the second transistor of the right subpixel are switched according to a left emission signal and a right emission signal, respectively.

11. The dual view display device of claim 10, further comprising:
a storage capacitor in each of the left subpixel and the right subpixel, the storage capacitor connected between the first and third nodes; and
a left light emitting diode and a right light emitting diode in the left subpixel and the right subpixel, respectively, each of the left light emitting diode and the right light emitting diode connected between the second and fourth transistors and a low level signal.

12. The dual view display device of claim 11, wherein a gate electrode of the first transistor, a first capacitor electrode of the storage capacitor and a drain electrode of the third transistor constitute the first node, and
wherein a drain electrode of the first transistor, a source electrode of the second transistor and a source electrode of the third transistor constitute the second node.

13. The dual view display device of claim 12, wherein a second capacitor electrode of the storage capacitor, a source electrode of the fifth transistor and a source electrode of the sixth transistor constitute the third node, and
wherein a drain electrode of the second transistor and a source electrode of the fourth transistor constitute the fourth node.

14. The dual view display device of claim 10, wherein, during a first period, the second, third, fourth and fifth transistors are turned on in response to the second scan signal, the left emission signal and the right emission signal of a logic low voltage, and the sixth transistor is turned off in response to the first scan signal of a logic high voltage, and
wherein, during a second period, the third, fourth and sixth transistors are turned on in response to the first scan signal and the second scan signal of a logic low voltage, and the second and fifth transistors are turned off in response to the left emission signal and the right emission signal of a logic high voltage.

15. The dual view display device of claim 14, wherein, during a third period, the second, third, fourth, fifth and sixth transistors are turned off in response to the first scan signal, the second scan signal, the left emission signal and the right emission signal of a logic high voltage, and
wherein, during a fourth period, the second and fifth transistors are turned on in response to the left emission signal and the right emission signal of a logic low voltage, and the third, fourth and sixth transistors are turned off in response to the first scan signal and the second scan signal of a logic high voltage.

16. The dual view display device of claim 15 wherein the fourth period includes an off section corresponding to the logic high voltage of the left emission signal and the right emission signal, and
wherein a width of the off section of the left emission signal and a width of the off section of the right emission signal are independently changed.
